(19) United States
(12) Patent Application Publication
(10) Pub. No.: US 2025/0384539 A1
(43) Pub. Date: Dec. 18, 2025

(54) METHOD FOR VALIDATING A MACHINE LEARNING ALGORITHM

(71) Applicant: Robert Bosch GmbH, Stuttgart (DE)

(72) Inventors: Clint Sebastian, Stuttgart (DE); Kexin Li, Ludwigsburg (DE); Laura Beggel, Stuttgart (DE); Sven Lindenschmid, Wannweil (DE); Thi Phuong Nhung Ngo, Karlsruhe-Neureut (DE)

(21) Appl. No.: 18/881,011

(22) PCT Filed: Jul. 12, 2023
(86) PCT No.: PCT/EP2023/069329

§ 371 Date: Jan. 3, 2025

(30) Foreign Application Priority Data
Jul. 21, 2022 (DE) 10 2022 207 450.5

(51) Int. Cl. G06T 7/00

(52) U.S. Cl. CPC G06T 7/0004; G06T 2207/20081; G06T 2207/20084; G06T 2207/30164

(57) ABSTRACT

A method for validating a machine learning algorithm. The machine learning algorithm is trained to recognize objects in image data. The method includes: providing a machine learning algorithm which is trained to recognize objects in image data; generating labeled validation data for validating the machine learning algorithm, wherein the validation data each contain at least one disturbance variable; and validating the machine learning algorithm on the basis of the generated validation data.

### FIELD

The present invention relates to a method for validating a machine learning algorithm and in particular to a method with which it is possible to validate, in a simple manner and with low resource consumption, how a trained machine learning algorithm responds to disturbance variables.

### BACKGROUND INFORMATION

Machine learning algorithms are based on using statistical methods to train a data processing system in such a way that it can perform a particular task without it being originally programmed explicitly for this purpose. The goal of machine learning is to construct algorithms that can learn and make predictions from data. These algorithms create mathematical models by means of which data can be classified, for example.

The term “robustness” also refers to the property of a method or system to function reliably even under unfavorable conditions. In the case of machine learning algorithms, robustness describes the degree of sensitivity to disturbance variables such as noise. With low robustness, even small disturbance variables lead to a high error rate in the processing of input data by the corresponding machine learning algorithm, while high robustness delivers correspondingly stable results even in the case of greater disturbances.

As part of quality assurance during a manufacturing process, the quality state of a test object or produced technical component is usually also subjected to an inspection. One or more quality characteristics, which are representative of the quality state of the technical component, are evaluated. Such quality characteristics may, for example, include shape properties or surface properties, wherein it is to be ascertained whether there is an anomaly in this regard. The term “anomalies” is generally understood to mean deviations from a given norm or a desired condition. On a smooth surface of a manufactured component, for example, a scratch may represent such an anomaly. Based on the ascertainment of the quality state, a decision can then be made, for example, whether the corresponding technical component can be further processed or should be rejected, for example automatically rejected.

In order to make it possible for such inspections to be carried out reliably and independently of human senses, it is conventional to use machine learning algorithms, in particular machine learning algorithms trained to ascertain or derive a quality state of the technical component from image data showing the technical component. However, during corresponding manufacturing processes, influences that are reflected as disturbance variables in the corresponding image data of the test objects may occur. Such influences may, for example, be vibrations, humidity, or even dust. Vibrations may, for example, be reflected as image noise in the image data. Humidity may, for example, cause local light refraction by forming small droplets on a camera lens, creating a blind spot. Dust, for example in the form of a veil or in the form of recognizable disturbance bodies, may in turn reduce image quality. If the corresponding machine learning algorithm is not sufficiently robust against such disturbance variables, such disturbance variables can lead to technical components being erroneously rejected, which leads to unnecessary costs, or to a component being erroneously not rejected, which can lead to safety risks during further processing and/or use of the technical component.

German Patent Application No. DE 10 2017 218 889 A1 describes an artificial intelligence module designed to process one or more input variables through an internal processing chain to one or more output variables, wherein the internal processing chain is defined by one or more parameters, and wherein the artificial intelligence module is designed to ascertain the parameter(s) from one or more memory values stored in a memory, wherein a distribution module is provided, which is designed to take one individual value each from one or more statistical distributions and to ascertain the parameter(s) therefrom, wherein at least one statistical characteristic variable of each statistical distribution depends on at least one memory value.

An object of the present invention is to specify a method with which it is possible to validate how a trained machine learning algorithm responds to disturbance variables.

The object may be achieved by a method for validating a machine learning algorithm including certain features of the present invention.

The object may also be achieved by a system for validating a machine learning algorithm having certain features of the present invention.

### DETAILED DESCRIPTION OF EXAMPLE EMBODIMENTS

According to an example embodiment of the present invention, the object may be achieved by a method for validating a machine learning algorithm, wherein the machine learning algorithm is trained to recognize objects in image data, and wherein the method comprises providing a machine learning algorithm which is trained to recognize objects in image data; generating labeled validation data for validating the machine learning algorithm, wherein the validation data each contain at least one disturbance variable; and validating the machine learning algorithm on the basis of the generated validation data.

The term “image data” refers to data that can be represented as an image or graphic by means of a special program.

The term “labeled validation image data” refers to labeled image data, or image data provided with ground-truth information, which are used to test or validate the machine learning algorithm and were usually not part of the training data for training the corresponding machine learning algorithm.

The term “comparison data containing a disturbance variable” is understood to mean corresponding image data or validation data influenced by a disturbance variable.

According to an example embodiment of the present invention, a method is specified, which, in a simple manner and without the need for complex and resource-intensive adaptations, provides a reliable statement about how error-prone the trained algorithm in question is when performing the task for which it is trained, in an environment in which the at least one disturbance variable, in particular a disturbance variable not contained in the corresponding training data. This, for example, makes it possible to select a sufficiently robust trained algorithm in order to ensure the desired process reliability in ascertaining a quality state of a technical component during a manufacturing process, whereby safety risks may be avoided.

As a whole, a method with which it is possible to validate how a trained machine learning algorithm responds to disturbance variables is thus specified according to the present invention.

According to an example embodiment of the present invention, the step of generating labeled validation data may comprise generating labeled validation data by using a generative adversarial network.

The term “generative adversarial network” is understood to mean a machine learning algorithm based on two interconnected artificial neural networks. The first artificial neural network, the generator, generates data which initially consist only of random statistical noise. The second neural network, the discriminator, analyzes or classifies the data generated by the first artificial neural network, wherein the discriminator is trained with real data, i.e., ground-truth information, in order to be able to evaluate this data. The generative adversarial network is usually trained via an iterative method, wherein the generator and the discriminator are trained alternately or in each iteration step. The aim is to ensure that the trained generative adversarial network can subsequently imitate real-world conditions as closely as possible.

The validation data may thus be generated in a simple manner by conventional algorithms without the need for complex and resource-intensive adaptations.

However, the fact that the step of generating labeled validation data comprises generating labeled validation data by using a generative adversarial network is only one possible embodiment. The validation data may also be generated by other conventional tools or functions for generating image data containing disturbance variables.

In one example embodiment of the present invention, the step of validating the machine learning algorithm furthermore comprises, for all generated validation data, respectively ascertaining a robustness value on the basis of ground-truth information regarding the corresponding validation data, a magnitude of the corresponding at least one disturbance variable, and at least one output value of the machine learning algorithm for the corresponding validation data; ascertaining a robustness value for the machine learning algorithm from the robustness values for all generated validation data; and comparing the robustness value for the machine learning algorithm to a threshold value for the machine learning algorithm.

The term “magnitude of the corresponding disturbance variable” is understood to mean a value describing the extent of the corresponding disturbance variable or of the disturbance variable influencing the corresponding validation data, or a degree of the corresponding disturbance variable.

The term “output values of the machine learning algorithm for the corresponding validation data” is furthermore understood to mean output values of the machine learning algorithm that are generated on the basis of the corresponding validation data.

The term “robustness value” is understood to mean a value characterizing or describing the robustness of the corresponding results.

The term “threshold value for the machine learning algorithm” is also understood in particular to mean a threshold value that the robustness value for the corresponding machine learning algorithm is not to fall below.

The validation of the machine learning algorithm can thus be carried out in a simple manner and with low resource requirements, for example requirements for memory capacities and/or processor capacities.

Furthermore, according to an example embodiment of the present invention, the labeled validation data may be generated from sensor data acquired by a sensor, wherein the labeled validation data relate to different alignments of the sensor.

A sensor, which is also referred to as a (measuring) probe, is a technical component that can detect certain physical or chemical properties and/or the material nature of its surroundings qualitatively or quantitatively as a measured variable.

The term “aligning the sensor” is understood to mean adjusting an orientation and/or a position of the sensor.

The conditions outside the actual data processing system on which the machine learning algorithm is validated can thus be detected in a simple manner and taken into account when validating the machine learning algorithm.

A further embodiment of the present invention furthermore specifies a method for ascertaining a quality state of a technical component by means of a machine learning algorithm which is trained to ascertain a quality state of the technical component on the basis of image data showing the technical component, wherein the method comprises providing image data showing the technical component; providing a machine learning algorithm which is trained to ascertain a quality state of the technical component on the basis of image data showing the technical component, wherein the machine learning algorithm has been validated by a method described above for validating a machine learning algorithm; and ascertaining the quality state of the technical component on the basis of the provided image data and the provided machine learning algorithm.

The term “quality state” is understood to mean a variable describing the quality or at least one quality characteristic of the technical component.

A method for ascertaining a quality state of a technical component by means of a machine learning algorithm is thus specified, which is based on a machine learning algorithm validated by a method with which it is possible to validate how a trained machine learning algorithm responds to disturbance variables. In particular, the machine learning algorithm is validated by a method, which, in a simple manner and without the need for complex and resource-intensive adaptations, provides a reliable statement about how error-prone the trained algorithm in question is when performing the task for which it is trained, in an environment in which the at least one disturbance variable, in particular a disturbance variable not contained in the corresponding training data, occurs. This, for example, makes it possible to select a sufficiently robust trained algorithm in order to ensure the desired process reliability in ascertaining a quality state of a technical component during a manufacturing process, whereby safety risks may be avoided.

A further embodiment of the present invention furthermore specifies a system for validating a machine learning algorithm, wherein the machine learning algorithm is trained to recognize objects in image data, wherein the system has a provision unit designed to provide a machine learning algorithm which is trained to recognize objects in image data; a generation unit designed to generate labeled validation data for validating the machine learning algorithm, wherein the validation data each contain at least one disturbance variable; and a validation unit designed to validate the machine learning algorithm on the basis of the generated validation data.

A system with which it is possible to validate how a trained machine learning algorithm responds to disturbance variables is thus specified.

In particular, a system is specified, which, in a simple manner and without the need for complex and resource-intensive adaptations, provides a reliable statement about how error-prone the trained algorithm in question is when performing the task for which it is trained, in an environment in which the at least one disturbance variable, in particular a disturbance variable not contained in the corresponding training data, occurs. This, for example, makes it possible to select a sufficiently robust trained algorithm in order to ensure the desired process reliability in ascertaining a quality state of a technical component during a manufacturing process, whereby safety risks may be avoided.

The generation unit may be designed to generate the labeled validation data by using a generative adversarial network. The validation data may thus be generated in a simple manner by conventional algorithms without the need for complex and resource-intensive adaptations.

However, the fact that the generation unit is designed to generate labeled validation data by using a generative adversarial network is only one possible embodiment. The validation data may also be generated by other conventional tools or functions for generating image data containing disturbance variables.

In one example embodiment of the present invention, the validation unit comprises a first ascertainment unit designed, for all generated validation data, respectively to ascertain a robustness value on the basis of ground-truth information regarding the corresponding validation data, a magnitude of the corresponding at least one disturbance variable, and output values of the machine learning algorithm for the corresponding validation data; a second ascertainment unit designed to ascertain a robustness value for the machine learning algorithm from the robustness values for all generated validation data; and a comparison unit designed to compare the robustness value for the machine learning algorithm to a threshold value for the machine learning algorithm. The validation of the machine learning algorithm can thus be carried out in a simple manner and with low resource requirements, for example requirements for memory capacities and/or processor capacities.

Furthermore, the generation unit may be designed to generate the labeled validation data from sensor data acquired by a sensor, wherein the labeled validation data relate to different alignments of the sensor. The conditions outside the actual data processing system on which the machine learning algorithm is validated can thus be detected in a simple manner and taken into account when validating the machine learning algorithm.

A further example embodiment of the present invention furthermore specifies a system for ascertaining a quality state of a technical component by means of a machine learning algorithm which is trained to ascertain a quality state of the technical component on the basis of image data showing the technical component, wherein the system comprises a first provision unit designed to provide image data showing the technical component; a second provision unit designed to provide a machine learning algorithm which is trained to ascertain a quality state of the technical component on the basis of image data showing the technical component, wherein the machine learning algorithm has been validated by a system described above for validating a machine learning algorithm; and an ascertainment unit designed to ascertain the quality state of the technical component on the basis of the provided image data and the provided machine learning algorithm.

According to an example embodiment of the present invention, a system for ascertaining a quality state of a technical component by means of a machine learning algorithm is thus provided, which is based on a machine learning algorithm validated by a system with which it is possible to validate how a trained machine learning algorithm responds to disturbance variables. In particular, the machine learning algorithm is validated by a system, which, in a simple manner and without the need for complex and resource-intensive adaptations, provides a reliable statement about how error-prone the trained algorithm in question is when performing the task for which it is trained, in an environment in which the at least one disturbance variable, in particular a disturbance variable not contained in the corresponding training data, occurs. This, for example, makes it possible to select a sufficiently robust trained algorithm in order to ensure the desired process reliability in ascertaining a quality state of a technical component during a manufacturing process, whereby safety risks may be avoided.

In summary, it should be noted that the present invention specifies a method for validating a machine learning algorithm and in particular a method with which it is possible to validate, in a simple manner and with low resource consumption, how a trained machine learning algorithm responds to disturbance variables.

The described embodiments and developments of the present invention can be combined with one another as desired.

Further possible embodiments, developments, and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the example embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a flowchart of a method for validating a machine learning algorithm according to example embodiments of the present invention.

FIG. 2 is a schematic block diagram of a system for validating a machine learning algorithm according to example embodiments of the present invention.

### DETAILED DESCRIPTION OF EXAMPLE EMBODIMENTS

In the figures, identical reference signs denote identical or functionally identical elements, parts or components, unless stated otherwise.

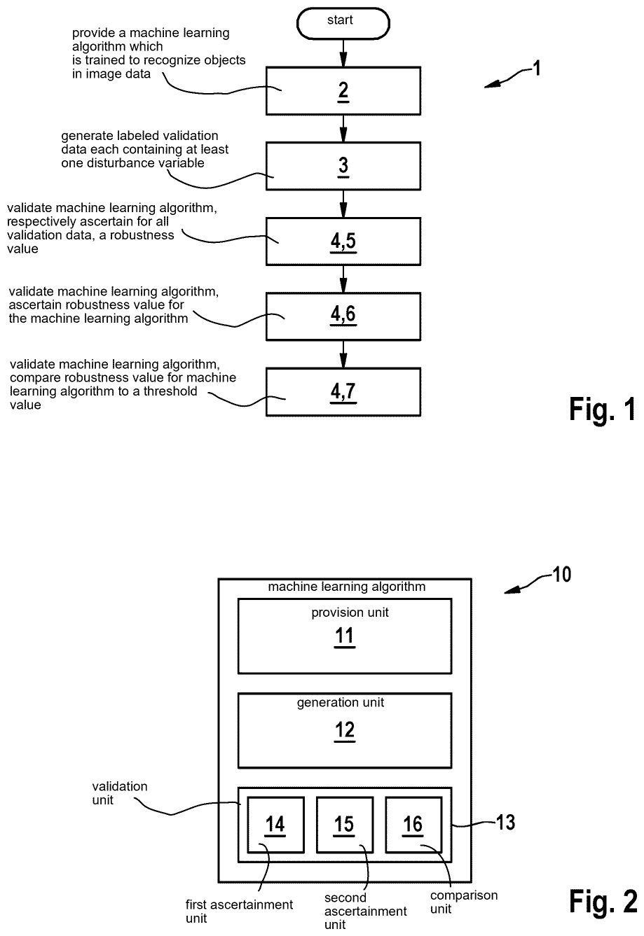

FIG. 1 shows a flowchart of a method for validating a machine learning algorithm 1 according to example embodiments of the present invention.

Deep-learning-based machine learning algorithms, in particular deep-learning-based machine learning algorithms for image processing, are known to be very sensitive to external interference or manipulation. Consequently, there is a need for methods that can be used to validate how a trained machine learning algorithm responds to disturbance variables, in particular such interference or manipulation.

FIG. 1 shows a method for validating a machine learning algorithm 1, wherein the machine learning algorithm is trained to recognize objects in image data, and wherein the method comprises a step 2 of providing a machine learning algorithm which is trained to recognize objects in image data; a step 3 of generating labeled validation data for validating the machine learning algorithm, wherein the validation data each contain at least one disturbance variable; and a step 4 of validating the machine learning algorithm on the basis of the generated validation data.

FIG. 1 thus shows a method, which, in a simple manner and without the need for complex and resource-intensive adaptations, provides a reliable statement about how error-prone the trained algorithm in question is when performing the task for which it is trained, in an environment in which the at least one disturbance variable, in particular a disturbance variable not contained in the corresponding training data, occurs. This, for example, makes it possible to select a sufficiently robust trained algorithm in order to ensure the desired process reliability in ascertaining a quality state of a technical component during a manufacturing process, whereby safety risks may be avoided.

As a whole, FIG. 1 thus shows a method 1 with which it is possible to validate how a trained machine learning algorithm responds to disturbance variables.

The method 1 can in particular be used to check whether an algorithm is robust against disturbance factors and whether it still provides correct output values when certain results are present. In particular, a quality gate is provided, for example a quality gate for deep-learning-trained machine learning algorithms.

The at least one disturbance variable may in particular be disturbance variables occurring during a manufacturing process of a technical component. Such disturbance variables may, for example, be vibrations, humidity, or even dust. Vibrations may, for example, be reflected as image noise in the corresponding image data. Humidity may, for example, cause local light refraction by forming small droplets on a camera, creating a blind spot on image data. Dust, for example in the form of a veil or in the form of recognizable disturbance bodies, may in turn reduce image quality.

In addition, the at least one disturbance variable may be at least one disturbance variable that is characteristic of the use or use case in which the machine learning algorithm is to be used.

The machine learning algorithm may furthermore be an artificial neural network, for example.

According to the embodiments of FIG. 1, step 3 of generating labeled validation data furthermore comprises generating labeled validation data by using a generative adversarial network.

As FIG. 1 also shows, step 4 of validating the machine learning algorithm furthermore comprises a step 5 of respectively ascertaining, for all generated validation data, a robustness value on the basis of ground-truth information regarding the corresponding validation data, a magnitude of the corresponding at least one disturbance variable, and output values of the machine learning algorithm for the corresponding validation data; a step 6 of ascertaining a robustness value for the machine learning algorithm from the robustness values for all generated validation data; and a step 7 of comparing the robustness value for the machine learning algorithm to a threshold value for the machine learning algorithm.

The threshold value for the machine learning algorithm may be based on requirements of the use or use case in which the machine learning algorithm is to be used. For example, the more safety-critical the subsequent use case is, the higher the threshold value that can be selected.

The magnitude of the at least one disturbance variable may also be measured or detected during the generation of the corresponding validation data, for example by monitoring corresponding parameters during the generation of the validation data.

The output values of the machine learning algorithm for the corresponding validation data may furthermore be corresponding prediction probabilities.

The robustness value for the machine learning algorithm may also be formed, for example, by averaging the robustness values of all generated validation data.

According to the embodiments of FIG. 1, the labeled validation data are furthermore generated from sensor data acquired by a sensor, wherein the labeled validation data relate to different alignments of the sensor.

The correspondingly validated machine learning algorithm may be trained on the basis of corresponding labeled training data to ascertain a quality state of a technical component, wherein the technical component may, for example, have been manufactured during a manufacturing process, and wherein technical components that do not meet specified quality standards may be automatically rejected. Furthermore, a corresponding machine learning algorithm may also be trained on the basis of labeled training data to control a controllable system or robotic system.

FIG. 2 shows a schematic block diagram of a system for validating a machine learning algorithm 10 according to embodiments of the present invention.

In particular, FIG. 2 shows a system for validating a machine learning algorithm 10, wherein the machine learning algorithm is trained to recognize objects in image data.

As FIG. 2 shows, the system 10 comprises a provision unit 11 designed to provide a machine learning algorithm which is trained to recognize objects in image data; a generation unit 12 designed to generate labeled validation data for validating the machine learning algorithm, wherein the validation data each contain at least one disturbance variable; and a validation unit 13 designed to validate the machine learning algorithm on the basis of the generated validation data.

The provision unit may in particular be a receiver designed to receive corresponding data. For example, the generation unit and the validation unit may furthermore each be realized on the basis of a code that is stored in a memory and can be executed by a processor.

According to the embodiments of FIG. 2, the generation unit 12 is furthermore designed to generate the labeled validation data by using a generative adversarial network.

As FIG. 2 furthermore shows, the validation unit 13 according to the embodiments of FIG. 2 also comprises a first ascertainment unit 14 designed, for all generated validation data, respectively to ascertain a robustness value on the basis of ground-truth information regarding the corresponding validation data, a magnitude of the corresponding at least one disturbance variable, and output values of the machine learning algorithm for the corresponding validation data; a second ascertainment unit 15 designed to ascertain a robustness value for the machine learning algorithm from the robustness values for all generated validation data; and a comparison unit 16 designed to compare the robustness value for the machine learning algorithm to a disturbance factor for the machine learning algorithm.

For example, the first ascertainment unit, the second ascertainment unit, and the comparison unit may each be realized on the basis of a code that is stored in a memory and can be executed by a processor.

According to the embodiments of FIG. 3, the generation unit 12 is also designed to generate the labeled validation data from sensor data acquired by a sensor, wherein the labeled validation data relate to different alignments of the sensor.

The sensor may in particular be an optical sensor, for example a camera.

The system 10 may also be designed to perform an above-described method for validating a machine learning algorithm.

1-8. (canceled)

9. A method for ascertaining a quality state of a technical component, during a manufacturing process, using a machine learning algorithm which is trained to ascertain a quality state of the technical component on the basis of image data showing the technical component, the method comprising the following steps:
providing image data showing the technical component;
providing a machine learning algorithm which is trained to ascertain a quality state of the technical component based on image data showing the technical component, wherein the machine learning algorithm has been validated by a method for validating a machine learning algorithm; and
ascertaining the quality state of the technical component based on the provided image data and the provided machine learning algorithm,
wherein the method for validating a machine learning algorithm includes:
providing the machine learning algorithm which is trained to recognize objects in image data,
generating labeled validation data for validating the machine learning algorithm, wherein the validation data each contain at least one disturbance variable, and
validating the machine learning algorithm based on the generated validation data, and wherein machine learning algorithm which is robust against the at least one disturbance variable has been selected based on validation results in order to ensure a desired process reliability in ascertaining a quality state of a technical component during a manufacturing process, wherein the at least one disturbance variable includes vibrations, humidity, and dust.

10. The method according to claim 9, wherein the step of generating labeled validation data includes generating labeled validation data by using a generative adversarial network.

11. The method according to claim 9, wherein the step of validating the machine learning algorithm further includes the following steps:
for each generated validation data, respectively ascertaining a robustness value based on ground-truth information regarding the validation data, a magnitude of a corresponding one of the at least one disturbance variable, and output values of the machine learning algorithm for the validation data;
ascertaining a robustness value for the machine learning algorithm from the robustness values for all generated validation data; and
comparing the robustness value for the machine learning algorithm to a threshold value for the machine learning algorithm.

12. The method according to claim 9, wherein the labeled validation data are generated from sensor data acquired by a sensor, and wherein the labeled validation data relate to different alignments of the sensor.

13. A system for ascertaining a quality state of a technical component, during a manufacturing process, using a machine learning algorithm which is trained to ascertain a quality state of the technical component based on image data showing the technical component, the system comprising:
a first provision unit configured o provide image data showing the technical component;
a second provision unit configured to provide a machine learning algorithm which is trained to ascertain a quality state of the technical component based on image data showing the technical component, wherein the machine learning algorithm has been validated by a system configured to validate a machine learning algorithm; and
an ascertainment unit configured to ascertain the quality state of the technical component based on the provided image data and the provided machine learning algorithm;
wherein the system for validating a machine learning algorithm includes:
a provision unit configured to provide a machine learning algorithm which is trained to recognize objects in image data,
a generation unit configured to generate labeled validation data for validating the machine learning algorithm, wherein the validation data each contain at least one disturbance variable, and
a validation unit configured to validate the machine learning algorithm based on the generated validation data;
wherein a machine learning algorithm which is robust against the at least one disturbance variable is provided based on validation results to ensure a desired process reliability in ascertaining a quality state of a technical component during a manufacturing process, wherein the at least one disturbance variable includes vibrations, humidity, and dust.

14. The system according to claim 13, wherein the generation unit is configured to generate the labeled validation data by using a generative adversarial network.

15. The system according to claim 13, wherein the validation unit includes:
a first ascertainment unit configured to, for each of the generated validation data, respectively ascertain a robustness value based on ground-truth information regarding the generated validation data, a magnitude of a corresponding one of the at least one disturbance variable, and output values of the machine learning algorithm for the generated validation data;
a second ascertainment unit configured to ascertain a robustness value for the machine learning algorithm from the robustness values for all of the generated validation data; and
a comparison unit configured to compare the robustness value for the machine learning algorithm to a threshold value for the machine learning algorithm.

16. The system according to claim 13, wherein the generation unit is configured to generate the labeled validation data from sensor data acquired by a sensor, and wherein the labeled validation data relate to different alignments of the sensor.
